(19) United States
(12) Patent Application Publication
(10) Pub. No.: US 2018/0210258 A1
(43) Pub. Date: Jul. 26, 2018

(54) FLEXIBLE LIQUID CRYSTAL DISPLAY DEVICE AND METHOD FOR MANUFACTURING THE SAME

(71) Applicant: Wuhan China Star Optoelectronics Technology Co., Ltd., Wuhan, Hubei (CN)

(72) Inventor: Yuejun Tang, Wuhan, Hubei (CN)

(73) Assignee: Wuhan China Star Optoelectronics Technology Co., Ltd., Wuhan, Hubei (CN)

(21) Appl. No.: 15/327,124

(22) PCT Filed: Dec. 30, 2016
(86) PCT No.: PCT/CN2016/113440

§ 371 Date: Jan. 18, 2017

(30) Foreign Application Priority Data
Dec. 27, 2016 (CN) 201611229295.5

(51) Int. Cl. G02F 1/1339; G02F 1/1333; G02F 1/1335

(52) U.S. Cl. CPC G02F 1/13394; G02F 1/133512; G02F 1/133305

(57) ABSTRACT

Disclosed are a flexible liquid crystal display device and a method for manufacturing the same. The flexible liquid crystal display device includes a black matrix. Polymer connecting structures are disposed in a region covered the black matrix. The polymer connecting structures are connected with an array substrate and a substrate arranged opposite the array substrate. The structure helps to solve the problems of dislocation of upper and lower substrates and unevenness of a liquid crystal cell gap occurred when a flexible/curved-surface/bendable/foldable liquid crystal display device is bent.

### CROSS-REFERENCE TO RELATED APPLICATIONS

The present application claims the priority of Chinese patent application CN201611229295.5, entitled “Flexible Liquid Crystal Display Device and Method for Manufacturing the Same” and filed on Dec. 27, 2016, the entirety of which is incorporated herein by reference.

### FIELD OF THE INVENTION

The present disclosure belongs to the technical field of liquid crystal displaying, and in particular, to a flexible liquid crystal display device and a method for manufacturing the same.

### BACKGROUND OF THE INVENTION

Recent years, an increasingly growing demand for non-planar display devices such as flexible liquid crystal display devices, bendable liquid crystal display devices, curved-surface liquid crystal display devices and foldable liquid crystal display devices has been seen. As stresses at various parts of these display devices are uneven when the display devices are bent, dislocation of upper and lower substrates and unevenness of a liquid crystal cell gap may occur.

As shown in FIG. 1, when a flexible/curved-surface/bendable/foldable liquid crystal display device is bent, as a stress undergone by a bending part gradually decreases towards both ends in an uneven manner, the liquid crystal cell gap is caused to be uneven. In other words, as shown in FIG. 1, d1 and d2 located at both ends are different from d located in the middle part. Besides, as each of the upper and lower substrates has a certain thickness, the upper and lower substrates may be dislocated when having a greater degree of bending. Both dislocation and unevenness of the liquid crystal cell gap may lead to a decline in display quality. For example, the brightness of the bending part of the display device and both ends of such part may be uneven, and there may be unevenness in color tones of the display device.

### SUMMARY OF THE INVENTION

One of the technical problems to be solved by the present disclosure is that when a flexible/curved-surface/bendable/foldable liquid crystal display device is bent, as a stress undergone by a bending part gradually decreases towards both ends in an uneven manner, a liquid crystal cell gap is caused to be uneven.

To solve the above technical problem, an embodiment of the present application firstly provides a flexible liquid crystal display device. The display device comprises an array substrate, and a substrate arranged opposite the array substrate. Liquid crystals are encapsulated between the array substrate and the substrate arranged opposite the array substrate, and a black matrix is disposed on the array substrate. Polymer connecting structures are disposed in a region covered by the black matrix, the polymer connecting structures being connected with the array substrate and the substrate arranged opposite the array substrate and being used for fixing the array substrate and the substrate arranged opposite the array substrate when the flexible liquid crystal display device is bent.

Preferably, the polymer connecting structures are formed by polymerizing liquid crystals doped with UV polymerizable monomers under UV light irradiation.

Preferably, spacers are further disposed between the array substrate and the substrate arranged opposite the array substrate, and the polymer connecting structures wrap around outer surfaces of the spacers.

Preferably, spacers are further disposed between the array substrate and the substrate arranged opposite the array substrate, and the polymer connecting structures are disposed in the region covered by the black matrix except areas where the spacers are provided.

Preferably, the polymer connecting structures are column-shaped or wall-shaped structures.

Preferably, the polymer connecting structures are disposed in an entire region covered by the black matrix, and the polymer connecting structures wrap the spacers.

Preferably, the polymer connecting structures are disposed in part of the region covered the black matrix and are wall-shaped structures parallel to one another, and long sides of the wall-shaped structures are disposed along a bending direction of the flexible liquid crystal display device.

The embodiment of the present application also provides a method for manufacturing a flexible liquid crystal display device. The method comprises steps of forming a black matrix on an array substrate; assembling the array substrate and a substrate arranged opposite the array substrate into a liquid crystal cell, and disposing a liquid crystal layer between the array substrate and the substrate arranged opposite the array substrate, the liquid crystal layer being doped with UV polymerizable monomers; disposing a photomask on an outer surface of the substrate arranged opposite the array substrate, a non-transparent region of the photomask covering a region of the liquid crystal cell that requires no irradiation; and irradiating the liquid crystal cell, from the substrate arranged opposite the array substrate, with UV light to enable the UV polymerizable monomers to undergo a polymerization reaction to form polymer connecting structures.

Preferably, the photomask includes a metal photomask or a photomask made of a photoresist or a black photoresist in which an UV absorbent is added.

Preferably, the UV polymerizable monomers comprise UV epoxy resin.

Compared with the prior art, one or more embodiments in the above solution may have the following advantages or beneficial effects.

As either an upper or lower substrate of the flexible/curved-surface/bendable/foldable liquid crystal display device employs a BOA substrate, and polymer connecting structures are disposed between the upper substrate and the lower substrate, the problems of dislocation of the upper and lower substrates and unevenness of the liquid crystal cell gap when the flexible/curved-surface/bendable/foldable liquid crystal display device is bent are solved. Moreover, as the polymer connecting structures are disposed in the region of the liquid crystal display device that is covered by the black matrix, the polymer connecting structures are prevented from affecting the display quality of the liquid crystal display device.

Other advantages, objectives and features of the present disclosure will be set forth in part in the following description, and in part will become apparent to those skilled in the art upon the observational study on the following or may be learnt from the practice of the present disclosure. The objectives and other advantages of the present disclosure will be achieved and obtained through the structure specifically pointed out in the description, the claims and the accompanying drawings.

### BRIEF DESCRIPTION OF THE DRAWINGS

The drawings are provided for further understanding of the technical solution of the present application or the prior art, and constitute one part of the description. Wherein, the drawings expressing the embodiments of the present application are used to explain the technical solution of the present application in conjunction with the embodiments of the present application, but they do not constitute limitations to the technical solution of the present application.

FIG. 1 is a schematic diagram illustrating a flexible/curved-surface/bendable/foldable liquid crystal display device in a bending state in the prior art;

FIG. 2 is a schematic diagram illustrating the structure of a flexible liquid crystal display device according to a first embodiment of the present disclosure;

FIG. 3 is a schematic diagram illustrating the distribution of polymer connecting structures according to the first embodiment of the present disclosure;

FIGS. 4a and 4b are schematic diagrams illustrating the distribution of polymer connecting structures according to a second embodiment of the present disclosure;

FIGS. 5 and 6 are schematic diagrams illustrating the distribution of polymer connecting structures according to a third embodiment of the present disclosure;

FIG. 7 is a schematic diagram illustrating the distribution of polymer connecting structures according to a fourth embodiment of the present disclosure;

FIG. 8 is a schematic diagram illustrating a flow process of a method for manufacturing a flexible liquid crystal display device according to a fifth embodiment of the present disclosure;

FIGS. 9a-9c are schematic diagrams illustrating manners of arrangement of upper/lower substrates of the flexible liquid crystal display device according to the fifth embodiment of the present disclosure;

FIG. 10 is a schematic diagram illustrating the film layer structure/order of a BOA substrate and a substrate according to the fifth embodiment of the present disclosure;

FIGS. 11a and 11b are schematic diagrams illustrating the formation of polymer connecting structures by adopting a photomask and UV light according to the fifth embodiment of the present disclosure; and

FIG. 12 is a schematic diagram illustrating a morphological structure of a panel of an application terminal of the flexible liquid crystal display device according to the embodiment of the present disclosure.

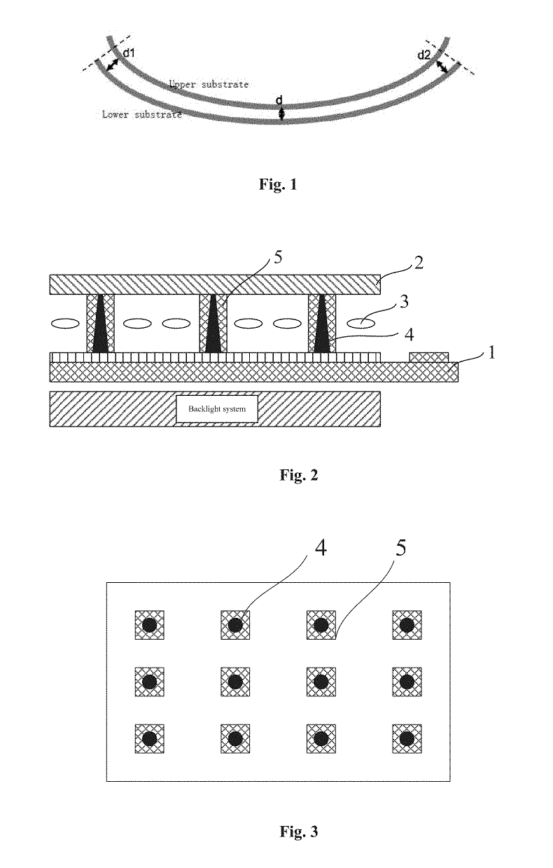

### DETAILED DESCRIPTION OF THE EMBODIMENTS

The implementations of the present disclosure will be described below in detail in conjunction with the accompanying drawings and the embodiments, thereby enabling the realization process concerning how the present disclosure applies technical means to solve technical problems and achieves corresponding technical effects to be fully understood and implemented. The embodiments of the present application and various features in the embodiments may be combined with one another without any conflict, and each of the technical solutions formed by them falls within the scope of protection of the present disclosure.

For the problems existing in the prior art, the present disclosure provides a liquid crystal display device with polymer connecting structures, which will be illustrated below in conjunction with specific embodiments.

### First Embodiment

FIG. 2 is a schematic diagram illustrating the structure of a flexible liquid crystal display device according to a first embodiment of the present disclosure, and what illustrated by the schematic diagram is a structure perpendicular to a cross section of a liquid crystal display screen.

As may be seen from the figure, the flexible liquid crystal display device in the embodiment of the present disclosure comprises an array substrate 1 and a substrate 2 that is arranged opposite the array substrate 1. Liquid crystals 3 are encapsulated between the array substrate 1 and the substrate 2. The array substrate 1 is a BOA (BM on Array) substrate.

A black matrix is a light-blocking structure on a display panel and may block light in regions located among pixel units to increase the contrast ratio of the liquid crystal display device, avoid color mixture among the pixel units and reduce external light reflection. The black matrix is generally disposed on a substrate where a color filter is located, namely on a substrate arranged opposite the array substrate. In the embodiment of the present disclosure, the BOA substrate is employed as the array substrate in order to form polymer connecting structures and enable the formed polymer connecting structures to be only located in regions covered by the black matrix to exert no influences on performance parameters of pixel units such as the aperture ratio.

As shown in FIG. 2, spacers 4 are disposed between the array substrate 1 and the substrate 2. The spacers 4 play a role in supporting a liquid crystal cell and are used for increasing the compressive strength of the liquid crystal display device. In the present embodiment, outer surfaces of the spacers 4 are wrapped by polymer connecting structures 5, and the polymer connecting structures 5 are connected with the array substrate 1 and the substrate 2.

A top view of the flexible liquid crystal display device of the embodiment in FIG. 2 is shown in FIG. 3. As may be seen from the figure, the outer surface of each of the spacers 4 is wrapped by a polymer film layer in places where the spacers 4 are disposed.

Generally, the polymer connecting structures 5 in the present embodiment are substantially formed with shapes according to shapes of the spacers 4 and may be prismatic or cylindrical, which are not limited by the present embodiment.

As the polymer connecting structures 5 are connected with the array substrate 1 and the substrate 2, the polymer connecting structures 5 have functions of fixing upper/lower substrates and maintaining the evenness of the liquid crystal cell gap when the liquid crystal display device is bent.

As the polymer connecting structures 5 are disposed in regions in the liquid crystal display device that are covered by the black matrix, not in central opening regions of pixels of the liquid crystal display device, the polymer connecting structures 5 may be prevented from affecting the display quality of the display device.

Meanwhile, as the spacers 4 are wrapped by the polymer connecting structures 5 in the present embodiment, the polymer connecting structures 5 may play a role in strengthening and supporting the spacers 4.

### Second Embodiment

The present embodiment is provided for positions of polymer connecting structures. Specifically, the polymer connecting structures 5 are disposed in regions covered by a black matrix except areas where spacers 4 are provided.

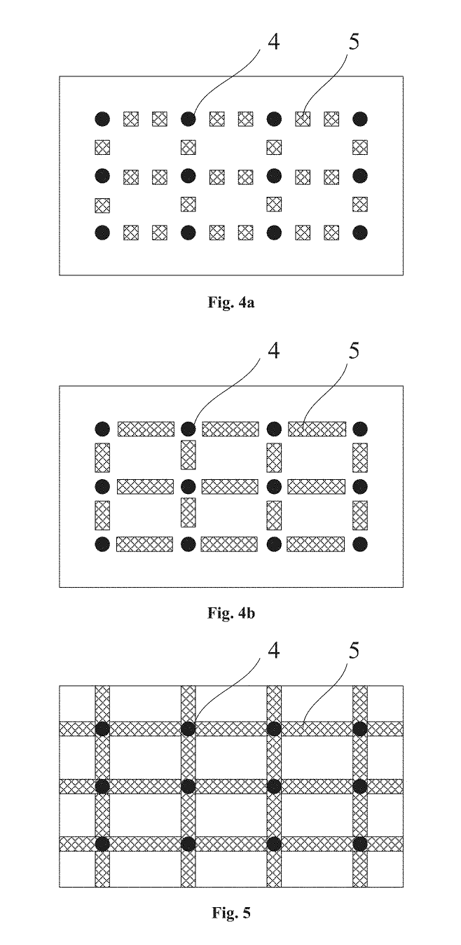

As shown in FIGS. 4a and 4b, the polymer connecting structures 5 are disposed in rows and/or columns where the spacers 4 are located, but in the regions covered by the black matrix except the areas where the spacers 4 are located. The polymer connecting structures 5 are connected with an array substrate 1 and a substrate 2 that is arranged opposite the array substrate 1.

Shapes of the polymer connecting structures 5 are no longer limited by structures of the spacers 4; therefore, the polymer connecting structures may be column-shaped structures (FIG. 4a) or wall-shaped structures (FIG. 4b). The column-shaped structures are similar to the spacers 4 in terms of appearance and may be prismatic or cylindrical. The wall-shaped structures are cuboid and have larger areas for connecting and fixing as comparison with the column-shaped structures.

As the polymer connecting structures 5 are connected with the array substrate 1 and the substrate 2, the polymer connecting structures 5 have functions of fixing upper/lower substrates and preventing the upper/lower substrates from being dislocated when the liquid crystal display device is bent, which indirectly prevents the spacers 4 located on steps or in grooves from being moved and dislocated, thus avoiding the case that a liquid crystal cell is uneven.

As the polymer connecting structures 5 are disposed in the regions in the liquid.

crystal display device that are covered by the black matrix, not in central opening regions of pixels of the liquid crystal display device, the polymer connecting structures 5 may be prevented from affecting the display quality of the display device.

### Third Embodiment

The present embodiment is provided for positions of polymer connecting structures. Specifically, the polymer connecting structures 5 are disposed in an entire region that is covered by a black matrix.

As shown in FIG. 5, the polymer connecting structures 5 cover entire rows and entire columns where spacers 4 are located, and the polymer connecting structures 5 in fact completely overlap a framework of the black matrix and are connected with an array substrate 1 and a substrate 2 that is arranged opposite the array substrate 1. It is readily appreciated that the polymer connecting structures 5 are cuboid wall-shaped structures.

As may be seen from FIG. 5, the spacers 4 are wrapped inside the polymer connecting structures 5.

In the present embodiment, as the polymer connecting structures 5 are connected with the array substrate I and the substrate 2, the polymer connecting structures 5 have functions of fixing upper/lower substrates and preventing the upper/lower substrates from being dislocated when the liquid crystal display device is bent, which indirectly prevents the spacers 4 located on steps or in grooves from being moved and dislocated, thus avoiding the case that a liquid crystal cell is uneven.

Furthermore, as the polymer connecting structures 5 are disposed in regions in the liquid crystal display device that are covered by the black matrix, not in central opening regions of pixels of the liquid crystal display device, the polymer connecting structures 5 may be prevented from affecting the display quality of the display device.

In practical application, the folding of a flexible/curved-surface/bendable/foldable liquid crystal display device only exists in parts of regions of the liquid crystal display device. For example, for a curved-surface liquid crystal display device, only a middle part of a display screen has a greater degree of bending. Consequently, the polymer connecting structures 5 may not be disposed across an entire display screen of the flexible liquid crystal display device, but may only be disposed in foldable regions of the flexible liquid crystal display device.

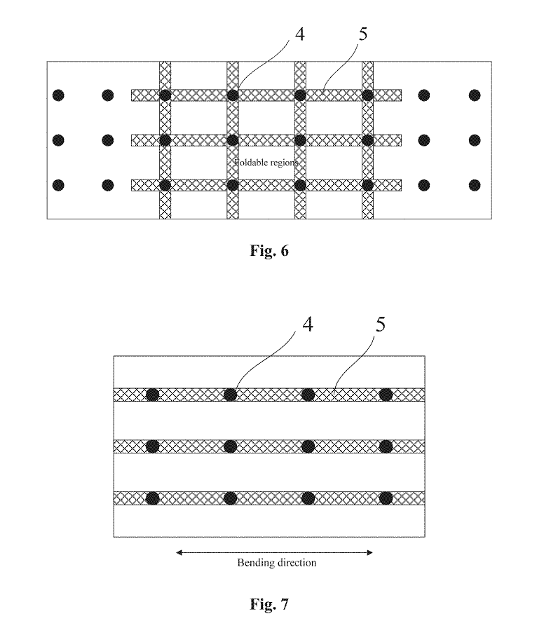

As shown in FIG. 6, the polymer connecting structures 5 are disposed in part of the region covered by the black matrix. As the polymer connecting structures 5 are reduced in number, the production process is simplified, and the yield is increased.

### Fourth Embodiment

The present embodiment is provided for positions of polymer connecting structures. Specifically, the polymer connecting structures 5 are disposed in part of a region covered by a black matrix, and specific positions of the polymer connecting structures are determined by a bending direction of a flexible liquid crystal display device.

As shown in FIG. 7, the polymer connecting structures 5 are wall-shaped structures parallel to one another, and the polymer connecting structures 5 are connected with an array substrate 1 and a substrate 2 that is arranged opposite the array substrate 1. The wall-shaped structures are in the shape of a cuboid. A long side of the cuboid is consistent with the bending direction of the flexible liquid crystal display device.

It is readily appreciated that when the flexible liquid crystal display device is bent along the direction shown in the figure, the polymer connecting structures 5 may play roles in fixing upper/lower substrates and maintaining evenness of a liquid crystal cell gap because the polymer connecting structures have a framework extending along the direction and are connected with the array substrate 1 and the substrate 2.

Spacers 4 disposed along the bending direction of the flexible liquid crystal display device are wrapped by the polymer connecting structures 5, and therefore, the polymer connecting structures 5 may play a role in strengthening and supporting the spacers 4 disposed along the bending direction of the flexible liquid crystal display device.

In addition, as the polymer connecting structures 5 are disposed in the region in the liquid crystal display device that is covered by the black matrix, not in the central opening regions of pixels of the liquid crystal display device, the polymer connecting structures 5 may be prevented from affecting the display quality of the display device.

### Fifth Embodiment

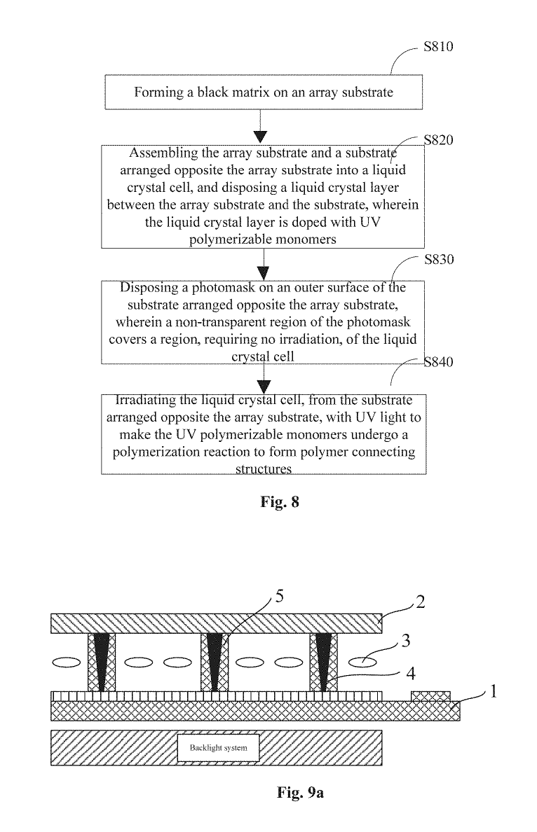

The present embodiment provides a method for manufacturing the polymer connecting structures 5 in various embodiments mentioned above. As shown in FIG. 8, the method comprises the following steps:

step S810, forming a black matrix on an array substrate;

step S820, assembling the array substrate and a substrate arranged opposite the array substrate into a liquid crystal cell, and disposing a liquid crystal layer between the array substrate and the substrate, the liquid crystal layer being doped with UV polymerizable monomers;

step S830, disposing a photomask on an outer surface of the substrate, a non-transparent region of the photomask covering a region of the liquid crystal cell that requires no irradiation; and

step S840, irradiating the liquid crystal cell from the substrate with UV light to cause the UV polymerizable monomers to undergo a polymerization reaction to form polymer connecting structures.

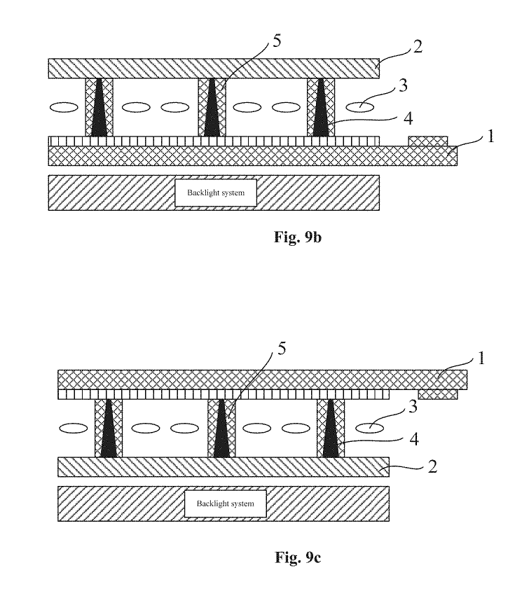

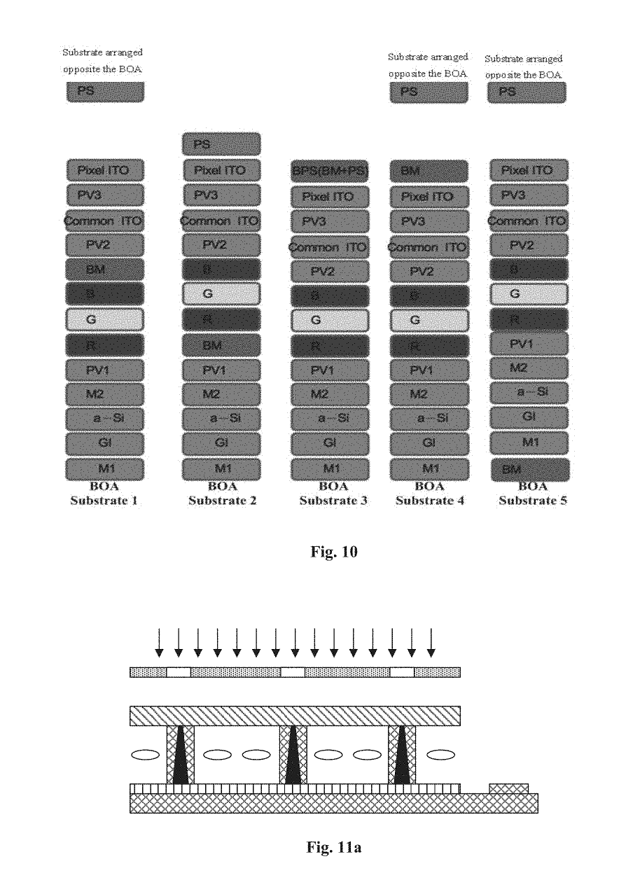

Specifically, in step S810, either upper or lower substrate of the flexible liquid crystal display device in the embodiment of the present disclosure is a BOA substrate as shown in FIGS. 9a-9c. Film layer structures/orders of the BOA substrate and the substrate arranged opposite the BOA substrate in FIGS. 9a-9c are seen in FIG. 10. The film layer structure/order of the BOA substrate may be selected from one of those shown in the figure and may also be other structures that are not shown, and the BOA substrates may be of various film layers that are illustrated, but are not limited thereto when one of the structures shown in the figure is selected.

As shown in FIG. 10, spacers 4 may be located on the BOA substrate (as shown in BOA substrates 2 and 3 in the figure) and may also be located on the substrates arranged opposite the BOA substrate (as shown in BOA substrates 1, 4 and 5 in the figure). The manufacturing of an RGB color resisting layer may be preceded by that of the black matrix BM (as shown in BOA substrates 2 and 5 in the figure), or the manufacturing of the BM layer may be preceded by that of the RGB color resisting layer (as shown in BOA substrates 1, 3 and 4 in the figure). The BM layer and the RGB color resisting layer may be adjacent (as shown in BOA substrates 1 and 2 in the figure), or may not be adjacent (as shown in BOA substrates 3, 4 and 5 in the figure) When the upper substrate is a BOA substrate, the BOA substrate 5 in the figure may be selected, and a high-temperature-resistant ferrous metal is taken as a BM material. In the BOA substrate 3 in the figure, the BM layer and spacers PS may be adjacent or located at a same layer and be manufactured by using a same material and using a gray tone photomask process.

In FIG. 10, the BOA substrate 1 is manufactured by sequentially forming a first metal layer M1, a gate insulation layer GI, a semiconductor layer a-Si, a second metal layer M2, a first protective layer PV1, color resisting layer (an RGB layer, and RGB are disposed on a same layer), a black matrix BM, a second protective layer PV2, a common electrode layer Common ITO, a third protective layer PV3 and a pixel electrode layer Pixel ITO. Spacers PS are formed on the substrate arranged opposite the BOA substrate.

The BOA substrate 2 is manufactured by sequentially forming a first metal layer M1, a gate insulation layer GI, a semiconductor layer a-Si, a second metal layer M2, a first protective layer PV1, a color resisting layer (an RGB layer, and RGB are disposed on a same layer), a second protective layer PV2, a common electrode layer Common ITO, a third protective layer PV3, a pixel electrode layer Pixel ITO and spacers PS.

The BOA substrate 3 is manufactured by sequentially forming a first metal layer M1, a gate insulation layer GI, a semiconductor layer a-Si, a second metal layer M2, a first protective layer PV1, a color resisting layer (an RGB layer, and RGB are disposed on a same layer), a second protective layer PV2, a common electrode layer Common ITO, a third protective layer PV3 and a pixel electrode layer Pixel ITO, and simultaneously forming a black matrix BM and spacers PS.

The BOA substrate 4 is manufactured by sequentially forming a first metal layer M1, a gate insulation layer GI, a semiconductor layer a-Si, a second metal layer M2, a first protective layer PV1, color resisting layer (an RGB layer, and RGB are disposed on a same layer), a second protective layer PV2, a common electrode layer Common ITO, a third protective layer PV3, a pixel electrode layer Pixel ITO and a black matrix BM, Spacers PS are formed on the substrate arranged opposite the BOA substrate.

The BOA substrate 5 is manufactured by sequentially forming a black matrix BM, a first metal layer M1, a gate insulation layer GI, a semiconductor layer a-Si, a second metal layer M2, a first protective layer PV1, a color resisting layer (an RGB layer, and RGB are disposed on a same layer), a second protective layer PV2, a common electrode layer Common ITO, a third protective layer PV3 and a pixel electrode layer Pixel ITO. Spacers PS are formed on the substrate arranged opposite the BOA substrate.

FIG. 10 illustrates a structure of a device using a-Si as a TFT semiconductor active layer. The figure illustrates the manufacturing order of layers, but the structure is not limited only to the structure illustrated in FIG. 10. The R/G/B color resisting layer is also illustrated in the figure, but it does not mean that a G color resist is located on an R color resist or a B color resist is located on the G color resist.

As can be seen from FIGS. 9a-9c and 10, the BOA substrate in FIG. 9a serves as the lower substrate, the spacers PS are located on the upper substrate, and the BOA substrates 1 and 4 in FIG. 10 may be employed; the BOA substrate in FIG. 9b serves as the lower substrate, the spacers PS are located on the lower substrate, and the BOA substrates 2 and 3 in FIG. 10 may be employed; and the BOA substrate in FIG. 9c serves as the upper substrate, the spacers PS are located on the lower substrate, and the BOA substrate 5 in FIG. 10 may be employed.

It should be noted that the BOA substrate in FIG. 10 is an FFS mode substrate, but in the embodiment of the present disclosure the display device may also be a VA-mode or TN-mode substrate and other-mode liquid crystal display device. FIG. 10 illustrates relative position relationship among the BM/the color resisting layer/the spacers PS and relative position relationship between the BM/the color resisting layer/the spacers PS and the first metal layer M1/the pixel electrode layer, but the present disclosure is not limited to the numbers of layers and the structures illustrate in the figure. For example, a second protective layer PV2 is not formed in the BOA substrate 2. For example, a third metal layer M3 serving as touch functional wiring is arranged below the second protective layer PV2 in the BOA substrate 1. When a-Si is used as a semiconductor layer, the above structures including the BM/the color resisting layer/the first metal layer M1/the pixel electrode layer or the spacers PS and the like in the BOA substrate conform to the relative position relationship and may also be other TFT structures.

In addition, a base substrate of the BOA substrate in the present embodiment can be made of, but is not limited to glass, polyimide (PI), cyclic olefin copolymers (COC), polyester resin (PET), polyether sulfone (PES), etc. A thin film transistor (ITT) device on the BOA substrate in the present embodiment is not limited to an a-Si TFT device and may also be other TFT devices such as an LTPS TFT device or an IGZO TFT device. Different TFT structures may be employed in addition to top gate type or bottom gate type TFTs when the LIPS TFT device or the IGZO TFT device is employed. Structures including the BM/the color resisting layer/the first metal layer M1/the pixel electrode layer or the spacers PS may conform to, but is not limited to the relative position relationship in FIG. 10.

In step S820, the liquid crystal layer is arranged between the upper substrate and the lower substrate of the liquid crystal cell, and the liquid crystal is doped with the UV polymerizable monomers. The monomer material, which is doped into the liquid crystals and which undergoes polymerization reaction under UV light irradiation to form a polymer, may be LTV epoxy resin, for example, products such as UV epoxy resin NOA-60 manufactured by the Norland company and a material manufactured by other companies and which can be polymerized under UV light irradiation. The present embodiment is not limited in this regard.

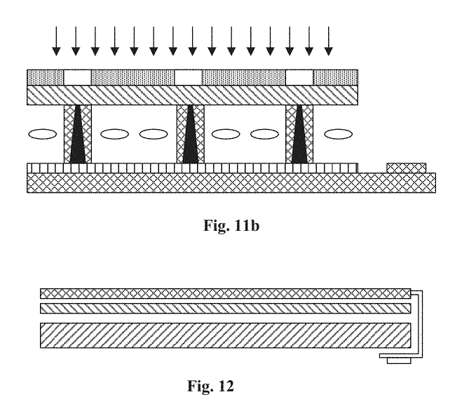

In step S830, the region, requiring no irradiation, of the liquid crystal cell, namely a region where the polymer connecting structures are not needed to be produced, may be covered by the metal photomask, which is shown in FIG. 11a. Specifically, non-transparent regions of the photomask correspond to pixel opening regions, and transparent regions of the photomask correspond to an upside or a downside of the BM.

In other embodiments of the present disclosure, a photomask made of a photoresist or a black photoresist in which an ultraviolet (UV) absorbent is added may be employed and disposed on an outer surface of the upper substrate, which is shown in FIG. 11b.

In step S840, ultraviolet light (UV light) is used to shine, from the substrate arranged opposite the array substrate and through openings of the photomask, on preset positions, by means of which polymerizable monomers mixed into the liquid crystal undergo polymerization reaction on the preset positions to form the polymer connecting structures which are then adhered to the upper and lower substrates.

As the liquid crystals are doped with the UV photosensitive polymerizable monomers, column-shaped or wall-shaped polymer connecting structures are formed by polymerization after the irradiation of the UV light.

In the present embodiment, either the upper or lower substrate employs the BOA substrate, and the liquid crystals doped with the UV polymerizable monomers is irradiated from the substrate arranged opposite the BOA substrate by using the UV light to ensure that the monomers are polymerized to form the polymer connecting structures. The polymer connecting structures are formed on or under the black matrix BM of the BOA substrate, instead of being located in the central opening regions of pixels of the liquid crystal display device, so that the polymer connecting structures are prevented from affecting the display quality in the center of the pixels.

In practical application, the flexible display device can be bent according to practical demands. As shown in FIG. 12, the BOA substrate can be located above, and the BOA substrate comprising a land region can be bent to the rear of a backlight system, so that a surface area of an application terminal is saved.

Finally, it should be noted that the liquid crystal display device in the embodiment of the present disclosure is not limited only to a transmissive display device, but may be a reflective display device.

Although the implementation disclosed by the present disclosure is as above, the content is only an implementation employed for facilitating the understanding of the present disclosure, but is not used for limiting the present disclosure. Any modifications or changes in terms of implementation forms and details may be made by anyone of those skilled in the art of the present disclosure without departing from the spirit and scope of the present disclosure, however, the patent scope of the present disclosure should still be subject to the scope defined in the claims.

1. A flexible liquid crystal display device, comprising an array substrate, and a substrate arranged opposite the array substrate,
wherein liquid crystals are encapsulated between the array substrate and the substrate arranged opposite the array substrate, and a black matrix is disposed on the array substrate,
wherein polymer connecting structures are disposed in a region covered by the black matrix, the polymer connecting structures being connected with the array substrate and the substrate arranged opposite the array substrate and being used for fixing the array substrate and the substrate arranged opposite the array substrate when the flexible liquid crystal display device is bent.

2. The flexible liquid crystal display device of claim I, wherein the polymer connecting structures are formed by polymerizing liquid crystals doped with UV polymerizable monomers wider UV light irradiation.

3. The flexible liquid crystal display device of claim 1, wherein spacers are further disposed between the array substrate and the substrate arranged opposite the array substrate, and the polymer connecting structures wrap around outer surfaces of the spacers.

4. The flexible liquid crystal display device of claim 1, wherein spacers are further disposed between the array substrate and the substrate arranged opposite the array substrate, and the polymer connecting structures are disposed in the region covered by the black matrix except areas where the spacers are provided.

5. The flexible liquid crystal display device of claim 4, wherein the polymer connecting structures are column-shaped or wall-shaped structures.

6. The flexible liquid crystal display device of claim 1. wherein the polymer connecting structures are disposed in an entire region covered by the black matrix, and the polymer connecting structures wrap the spacers.

7. The flexible liquid crystal display device of claim 1, wherein the polymer connecting structures are disposed in part of the region covered the black matrix and are wall-shaped structures parallel to one another, and long sides of the wall-shaped. structures are disposed along a bending direction of the flexible liquid crystal display device.

8. A method for manufacturing a flexible liquid crystal display device, comprising:
forming a black matrix on an array substrate;
assembling the array substrate and a substrate arranged opposite the array substrate into a liquid crystal cell, and disposing a liquid crystal layer between the array substrate and the substrate arranged opposite the array substrate, wherein the liquid crystal layer is doped with UV polymerizable monomers;
disposing a photomask on an outer surface of the substrate arranged opposite the array substrate, wherein a non-transparent region of the photomask covers a region of the liquid crystal cell that requires no irradiation; and
irradiating the liquid crystal cell, from the substrate arranged opposite the array substrate, with UV light to enable the UV polymerizable monomers to undergo a polymerization reaction to form polymer connecting structures.

9. The method for manufacturing the flexible liquid crystal display device of claim 8, wherein the photomask includes a metal photomask or a photomask made of a photoresist or a black photoresist in which an UV absorbent is added. 10, The method for manufacturing the flexible liquid crystal display device of claim 8, wherein the UV polymerizable monomers comprise UV epoxy resin.
